(19) United States
(12) Patent Application Publication
(10) Pub. No.: US 2008/0066162 A1
(43) Pub. Date: Mar. 13, 2008

(54) Information processing apparatus, information processing method, and computer readable medium storing series of instructions for information processing

(75) Inventor: Yoshihiro Saito, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/785,862

(22) Filed: Apr. 20, 2007

(30) Foreign Application Priority Data
Sep. 7, 2006 (JP) 2006-242708

(51) Int. Cl. G06F 7/04

(52) U.S. Cl. 726/4

(57) ABSTRACT

An information processing apparatus includes an operating part that accepts a user input and a controller that authenticates a user, accepts a command provided by the authenticated user from the operating part, executes a process in accordance with the command, and exerts control to accept or reject a user input for the process, according to termination of the process.

### CROSS-REFERENCE TO RELATED APPLICATIONS

This application is based on and claims priority und er 35 USC 119 from Japanese Patent Application No. 2006-242708 filed on Sep. 7, 2006.

### BACKGROUND

1. Technical Field

The present invention relates to an information processing apparatus, an information processing method, and a computer readable medium storing a series of instructions for information processing.

2. Related Art

As an information processing apparatus intended for shared use by plural users, there are various kinds of terminal equipment, automatic teller machines (ATM) at banks and the like, and so-called complex machines equipped with plural functions such as copy, scanner, and printer functions.

### SUMMARY

One aspect of the present invention resides in an information processing apparatus including an operating part that accepts a user input and a controller that authenticates a user, accepts a command provided by the authenticated user from the operating part, executes a process in accordance with the command, and exerts control to accept or reject a user input for the process, according to termination of the process.

### BRIEF DESCRIPTION OF THE DRAWINGS

An exemplary embodiment of the present invention will be described in detail based on the following figures, wherein:

FIG. 1 is a structural block diagram showing an example of an information processing apparatus relevant to an exemplary embodiment of the present invention;

FIG. 2 is a block diagram showing an example of a configuration of a central unit of the information processing apparatus relevant to the exemplary embodiment of the present invention;

FIG. 3 illustrates exemplary contents of a condition setting table stored in the information processing apparatus relevant to the exemplary embodiment of the present invention; and

FIG. 4 is a flowchart illustrating an example of processing in accordance with a series of instructions for information processing by the information processing apparatus relevant to the exemplary embodiment of the present invention.

### DETAILED DESCRIPTION

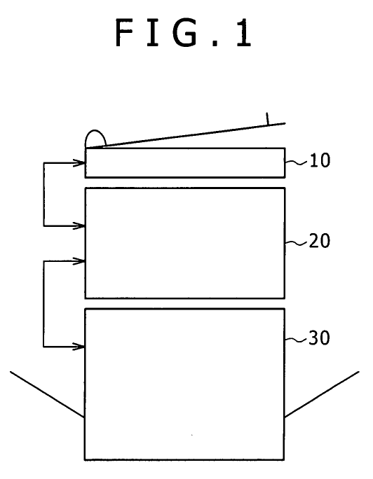

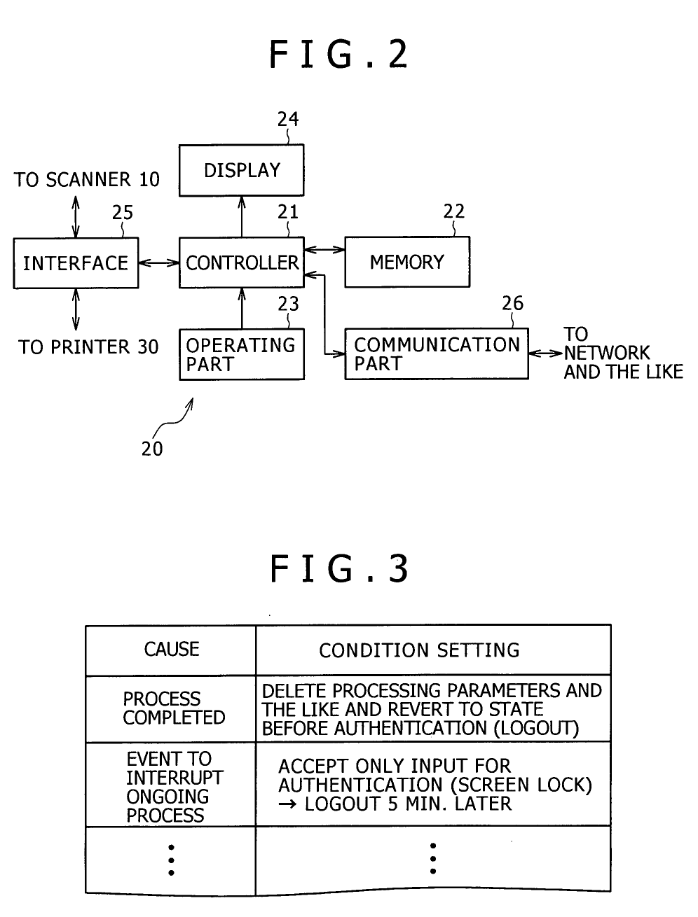

An exemplary embodiment of the present invention will now be described with reference to the drawings. An information processing apparatus relevant to the exemplary embodiment of the present invention is, for example, the above-mentioned complex machine. An example thereof, as shown in FIG. 1, includes an optical reader (scanner) 10, a central unit 20, and an image forming equipment (printer) 30. The central unit 20, as shown in FIG. 2, includes a controller 21, a memory 22, an operating part 23, a display 24, an interface 25 via which information is transferred, and a communication unit 26.

The scanner 10 optically reads a medium on which an image has been formed and outputs image data obtained by reading.

The controller 21 of the central unit 20 is a Central Processing Unit (CPU) and the like that operate in accordance with a series of instructions (program) for information processing. The controller 21 operates in accordance with the series of instructions stored in the memory 22 which is a computer readable storage medium or a computer readable storage medium such as a Compact Disk Read Only Memory (CD-ROM). In the present exemplary embodiment, the controller 21 authenticates a user according to a user input provided via the operating part 23, accepts a command from the authenticated user, and executes any of processes such as scan, copy, and print by controlling the scanner 10 or the printer 30. The controller 21 may change mode of user input acceptance according to prescribed conditions. Specific operations of the controller 21 will be detailed later.

The memory 22 is built up with storage elements such as Random Access Memory (RAM) and Read Only Memory (ROM) and holds a program executed by the controller 21. In the memory 22, pre-registered user information (e.g., user name and associated password information) is retained.

The operating part 23 includes a touch panel which includes transparent electrodes overlaid on the display 24, a numeric keypad, switches, etc. The operating part 23 accepts a user input and outputs the input signal or data to the controller 21. The display 24 is, for example, a liquid crystal display and the like and displays information in accordance with an input command.

The interface 25 is connected to the scanner 10 and the printer 30, accepts an input of image data obtained by read operation by the scanner 10, and outputs the image data to the controller 21. Also, the interface 25 outputs, inter alia, a command to form an image and image data from which the image is formed to the printer 30 in accordance with a command issued from the controller 21.

The communication unit 26 is a network interface and the like and outputs data received over a communication unit such as a network to the controller 21. Also, the communication unit 26 transmits data to a specified destination in accordance with a command issued from the controller 21.

Based on the command to form an image issued from the central unit 20 and image data from which the image is formed, the printer 30 forms the image from the image data on a recording medium such as paper.

In the complex machine as the information processing apparatus of the present exemplary embodiment, the controller 21 first authenticates a user. For example, the controller 21 displays a message prompting the user to enter the user name and a password on the display 24 and accepts an input of the user name and the password from the operating part 23.

The controller 21 checks whether the thus entered user name and password are held, associated with each other, in the memory 22. If they are held in association, the controller 21 determines that the user has been authenticated and displays a screen for accepting a command to execute a process on the display 24.

Here, the controller 21 will accept a command for, for example, scan, copy, or other operation, as a process which is performed by the complex machine. According to the accepted command, the controller 21 carries out appropriate processing such as image data reading, printing, or data transmission, by controlling the scanner 10, the printer 30, and other components.

If a command for copy is input, the controller 21 accepts processing parameters related to the copy, specified by the user, such as the number of copies, a scale-up or scale-down factor, and selection of color/monochrome, and stores these parameters into the memory 22. When a start command is input by the user, the controller 21 causes the scanner 10 to start image reading and stores image data that has been read by the scanner 10 serially into the memory 22. Also, the controller 21 executes image processing such as scaling up or scaling down the image by the set scale-up or scale-down factor, sends the thus processed image data to the printer 30, and causes the printer to perform the image forming process to produce as many copies as the set number of copies.

During a series of these operations, the controller 21 in the present exemplary embodiment may set the condition to accept or reject a user input for a process to a prescribed condition, based on the occurrence of a prescribed event irrelevant to user input operation via the operating part 23. For example, upon the occurrence of an event that a process has terminated (a print job has terminated in the case of printing), the controller 21 may delete the processing parameters stored in the memory 22 as well as the image data and the like read and stored into the memory 22 during the process from the memory 22, cause the apparatus to revert to the state before authentication (the state where the screen prompting the user to enter information for authentication is displayed), and reject a user input for any process such as scan and copy except for input for authentication.

The controller 21 may reject a user input for any process such as scan and copy except for input for authentication with the processing parameters stored in the memory 22 and the image data and the like read and stored into the memory 22 during the process remaining held in the memory 22 (screen locking). In the case of doing so, the controller 21 keeps the authenticated user name and password held as the current user information in the memory 22. Then, during the screen locking, the controller 21 checks whether the user name and password entered for authentication matches the current user information held in the memory 22. Here, if the entered user name and password match the current user information (that is, when the user has been authorized again), the controller 21 exerts control to allow the user to request a process of information related to the process performed before the apparatus is screen locked. With, for example, the image data and the like read and stored into the memory 22 during the process remaining held in the memory 22, the controller 21 reenters the mode in which it accepts a user input for any process such as scan and copy other than input for authentication.

Here, if the entered user name and password do not match the current user information, the controller 21 may display a message like “the apparatus is in use by another user” and reject a user input for any process except for input for authentication. Once control has been effected to reject a user input by screen locking, control is exerted to reject input provided by a different user from the current user for a process of information which is an object to be processed by the process requested by the current user (or information which can be selected as an object to be processed by the process requested by the current user).

If the entered user name and password do not match the current user information, the controller 21 may check whether the entered user name and password are stored, associated with each other, in the memory 22. If they are stored, the controller 21 may delete the processing parameters stored in the memory 22 as well as the image data and the like read and stored into the memory 22 during the process from the memory 22 and then may enter the mode in which it accepts a user input for a process (a user input for scan, copy, etc.) other than input for authentication.

Although, in the description hereinbefore, the controller 21 rejects a user input for any process except for input for authentication after the termination of the ongoing process, the controller 21 may determine whether to accept or reject a user input by the condition depending on process type for which a user input is provided. This condition may be set to accept, for example, a command for copy, but reject a command for scan and the like.

Further, the controller 21 may change the condition regarding user input acceptance in relation to time elapsed. From the time at which the apparatus has entered the above screen lock state, upon the elapse of a given time period which has been predetermined, the controller 21 may delete the processing parameters stored in the memory 22 as well as the image data and the like read and stored into the memory 22 during the process from the memory 22 and cause the apparatus to revert to the state before authentication.

In the description hereinbefore, by way of example, the termination of the ongoing process has been described as a cause that changes the condition of user input acceptance; however, in the information processing apparatus of the present exemplary embodiment, the cause that changes the condition of user input acceptance is not limited to this. For example, the cause may be the occurrence of an event to interrupt the ongoing process instead of or in addition to the termination of the ongoing process. Here, such an event to interrupt the ongoing process is, for example, an event of paper-out and the like in the printer 30 in the case of the complex machine of the present exemplary embodiment.

The condition of user input acceptance may be changed when an event prescribed as such an event to interrupt the ongoing process occurs.

For example, time may be measured after the last user input provided via the operating part 23 and, when the measured time has become equal to a given period of time which has been predetermined, a logout process may be performed; whereas, screen locking may take place upon the detection of the termination of the ongoing process or an event to interrupt the ongoing process. In this case, until the state of no input via the operating part continues for the given period of time, when the process has terminated or has been interrupted, the controller 21 rejects a user input for a process.

If, before the completion of one process commanded from the authenticated user, a user input for the next process is provided, the controller 21 may not change the condition of user input acceptance until the next process is completed. For example, given that, after the user inputs a command for scan, the user further inputs a command for copy during the execution of the scan process; only after the completion of the copy process, the controller 21 may change the condition of user input acceptance, such as causing the apparatus to revert to the state before authentication, as described above.

### [Document Management]

The controller 21 in the information processing apparatus of the present exemplary embodiment may execute a process as a document management function. That is, the controller 21 may store image data read by the scanner 10, as requested by a user, or image data transferred over a communication unit such as a network from a computer (such as a personal computer) as a document into the memory 22, associated with information to identify the user, so that the document may be used for printing and other operations requested by the user.

In this case, only documents associated with an authenticated user are presented to the user as candidates to be processed such as those to be printed, displayed, or transmitted, so that documents of a user will not be used for viewing or printing requested by any other user. The user performs an operation to select a document to be processed from the candidates.

In the case where the controller 21 executes the process as the document management function in this way, the controller 21 changes the condition of user input acceptance to be applied as the condition to accept or reject a user input provided by a particular user upon the occurrence of a prescribed event such as the termination of the ongoing process, irrelevant to user input operation via the operating part 23. For example, the condition is applied as the condition to accept or reject a user input provided by a “guest” user that has been defined beforehand. When such a prescribed event occurs during the use of the apparatus by, for example, a user A, the condition to accept or reject a user input provided by a “guest” user is set. This prevents any document of the user A from being presented as an object to be processed.

Although, in the description hereinbefore, the acceptance condition is changed by an event irrelevant to user input operation via the operating part 23, the condition of user input acceptance may be changed by an event in which no user input has been provided via the operating part 23 for a predetermined certain period of time or longer. Further, the condition of user input acceptance may be changed by an event in which the user provides an input to temporarily stop the ongoing process.

If there are plural causes that may change the condition of user input acceptance, a condition setting table in which a condition of acceptance is defined for each cause, as shown in FIG. 3, may be stored in the memory 22. When an event as a cause included in the condition setting table occurs, the controller 21 accepts a user input by the condition of user input acceptance defined in association with the cause.

For example, when the ongoing process has terminated, the controller 21 may delete the processing parameters and the like that have so far been set by the user and held in the memory 22 and cause the apparatus to revert to the state in which the apparatus accepts only a user input for authentication (logout process).

On an event to interrupt the ongoing process, such as paper-out, the controller 21 may cause the apparatus to revert to the state in which the apparatus accepts only a user input for authentication with the processing parameters that have so far been set by the user and held in the memory 22 and image data and the like remaining held in the memory 22 (the above-mentioned screen locking).

Further, the condition setting table may include a definition that the condition is changed after the elapse of a given period of time. Screen locking may take place when an event to interrupt the ongoing process such as paper-out occurs, and the logout process may be performed upon the elapse of a given period of time.

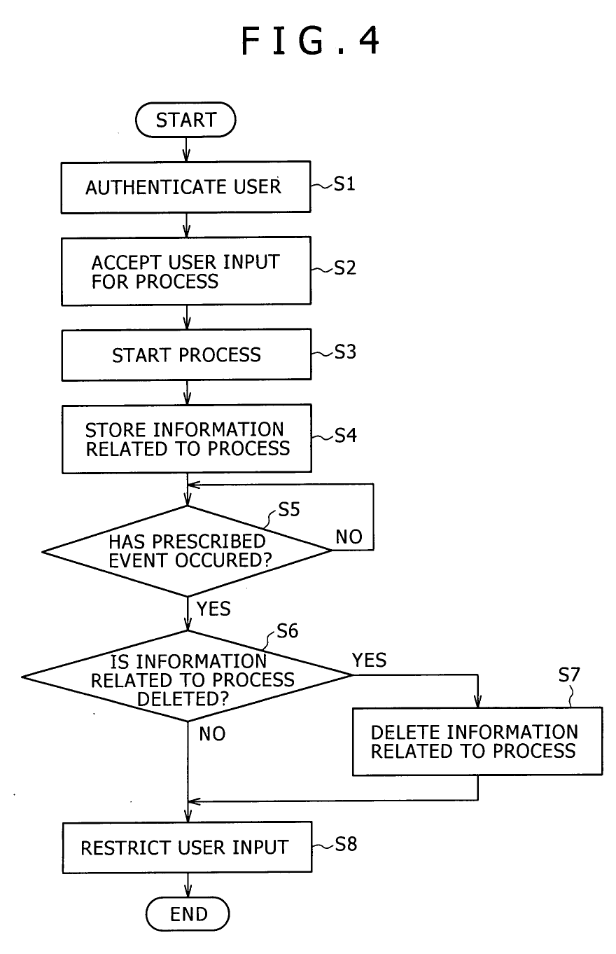

Referring to FIG. 4, the controller 21 of the information processing apparatus of the present exemplary embodiment first authenticates a user (S1), accepts a user input for a process provided by the authenticated user (S2), and starts the process (S3). The controller 21 stores entered or acquired information related to the process (S4) and continues the process. The controller 21 determine whether a prescribed event which has been predetermined, such as the termination of the ongoing process or an event to interrupt the ongoing process, has occurred during the process. If a prescribed event has not occurred, the controller 21 continues the process.

When a prescribed event has occurred, as determined at step S5, the controller 21 determines whether to delete the information related to the process, which has been stored during the process, referring to the condition of user input acceptance (mode in which a user input is restricted) predefined in association with the event occurred (S6). Here, when the applied condition is to delete the information related to the process, the controller 21 deletes the information related to the process (S7) and restricts a user input according to the condition of user input acceptance (mode in which a user input is restricted) prescribed in association with the event occurred (S8).

In the present exemplary embodiment, when not only a user input via the operating part but also an event such as, for example, the termination of the ongoing process (including an interruption of the process) is detected, logout or screen locking takes place to restrict user operation. Therefore, the opportunity of abuse can be reduced as compared with when user input acceptance is controlled only if there is no input via the operating part for a given period of time.

The present invention may be embodied in other specific forms without departing from its spirit or characteristics. The described exemplary embodiment is to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An information processing apparatus, comprising:
an operating part that accepts a user input; and
a controller that authenticates a user, accepts a command provided by the authenticated user from the operating part, instructs execution of a process in accordance with the command, and exerts control to accept or reject a user input for the process, according to termination of the process.

2. The information processing apparatus according to claim 1, further comprising a memory that stores information related to the process,
wherein the controller deletes the information related to the process.

3. The information processing apparatus according to claim 2, wherein, once the controller has effected control to reject a user input for the process, the controller exerts control to reject input provided by a different user from the user for a process of the information related to the process.

4. The information processing apparatus according to claim 3, wherein, if the user who has requested the process is authorized again, the controller exerts control to allow the user to request a process of the information related to the process stored in the memory.

5. The information processing apparatus according to claim 1, wherein the control exerts control to reject a user input depending on a process type for which a user input is provided.

6. The information processing apparatus according to claim 1, wherein the termination of the process includes an interruption of the process.

7. The information processing apparatus according to claim 1, wherein the apparatus does not reject a user input for the process even if the process has terminated accepting a new command from the operating part before the termination of the process.

8. The information processing apparatus according to claim 1, wherein the process includes at least one of a printing process, a scanning process, a copying process.

9. A computer readable medium storing a series of instructions for information processing, causing a computer to execute a process comprising:
accepting a user input via an operating part;
authenticating a user;
accepting a command provided by the authenticated user from the operating part;
instructing execution of a process in accordance with the command; and
exerting control to apply a prescribed condition to accept or reject a user input for the process, according to termination of the process.

10. An information processing apparatus, comprising:
an operating part that accepts a user input; and
a controller that authenticates a user, accepts a command provided by the authenticated user from the operating part, instructs execution of a process in accordance with the command, and exerts control to reject a user input for the process when having detected that there is no user input via the operating part for a given period of time or that the process has terminated,
the controller exerting control over the process to reject a user input for the process if the process has terminated even before the given period of time has elapsed.

11. An information processing apparatus, comprising:
an operating part that accepts a user input; and
a controller that authenticates a user, accepts a command provided by the authenticated user from the operating part, instructs execution of a process in accordance with the command, and exerts control to reject a user input for the process, when having detected that there is no user input via the operating part for a given period of time or that the process has been interrupted,
the controller exerting control over the process to reject a user input for the process if the process has been interrupted even before the given period of time has elapsed.

12. The information processing apparatus according to claim 10, wherein the apparatus does not reject a user input for the process even if the process has terminated accepting a new command from the operating part before the termination of the process.

13. An information processing method, comprising:
accepting a user input;
authenticating a user;
accepting a command provided by the authenticated user;
instructing execution of a process in accordance with the command; and
exerting control to accept or reject a user input for the process, according to termination of the process.
